(19) United States
(12) Patent Application Publication
(10) Pub. No.: US 2026/0132037 A1
(43) Pub. Date: May 14, 2026

(54) AMMONIA SYNTHESIS WITH CO2-NEUTRAL HYDROGEN

(71) Applicants: thyssenkrupp Uhde GmbH, Dortmund (DE); thyssenkrupp AG, Essen (DE)

(72) Inventors: Nicolai ANTWEILER, Essen (DE); Karsten BUEKER, Dortmund (DE); Bernd KEIL, Dortmund (DE)

(73) Assignees: thyssenkrupp Uhde GmbH, Dortmund (DE); thyssenkrupp AG, Essen (DE)

(21) Appl. No.: 18/686,334

(22) PCT Filed: Aug. 23, 2022
(86) PCT No.: PCT/EP2022/073396

§ 371 Date: Feb. 23, 2024

(30) Foreign Application Priority Data
Aug. 25, 2021 (BE) BE 2021/5673
Aug. 25, 2021 (DE) 10 2021 209 338.8

(51) Int. Cl. C01C 1/04; C01B 3/24

(52) U.S. Cl. CPC C01C 1/0458; C01B 3/24; C01B 2203/0266; C01B 2203/068; C01B 2203/0838

(57) ABSTRACT

The present disclosure relates to an apparatus and a process for CO₂-neutral hydrogen production and subsequent further processing to afford ammonia.

The present invention relates to an apparatus and a process for CO₂-neutral hydrogen production and subsequent further processing to afford ammonia.

Today, the majority of the hydrogen for ammonia synthesis is produced from methane by steam reforming. Due to the large amount of ammonia produced, this has a great influence on worldwide CO₂ emissions.

It is therefore desirable to reduce CO₂ emissions. One option under discussion is the production of hydrogen by electrolysis using electricity from renewable energy sources, for example from solar power. However, due to the high energy demand for electrochemical water splitting, the process is energetically unfavorable and therefore relatively costly. Yet the conversion of, for example, solar electricity into ammonia for example as an energy storage form that is easy to store, easy to transport and easy to make accessible again has a lot of merit.

Nevertheless, in order to be able to meet the high demand especially in the fertilizer industry it is sensible to search for alternatives.

U.S. Pat. No. 7,094,384 B 1 discloses the thermal composition of hydrocarbons and the synthesis of ammonia.

WO 2002 038 499 A 1 discloses a process for producing ammonia from a nitrogen-hydrogen mixture from natural gas.

### US 2019 0144768 A 1 Discloses the Synthesis of Ammonia.

It is an object of the present invention to provide a cost-effective but CO₂-free hydrogen source for large industrial scale ammonia synthesis

This object is achieved by the apparatus having the features specified in claim 1 and by the process having the features specified in claim 9. Advantageous developments are apparent from the dependent claims, the following description, and the drawings.

The ammonia synthesis apparatus according to the invention is used for producing hydrogen and for converting the hydrogen into ammonia. The ammonia synthesis apparatus comprises a converter for converting nitrogen and hydrogen into ammonia. Corresponding converters are known to those skilled in the art and typically run using the Haber-Bosch process, i.e. at elevated temperature and high pressure over an appropriate catalyst. The ammonia synthesis apparatus further comprises a separation apparatus for separating the ammonia from the gas stream. This is also known from the classical Haber-Bosch process. The ammonia synthesis apparatus has a reactant inlet and a product outlet and the separation apparatus has a gas mixture inlet and a reactant gas outlet. The product outlet of the ammonia synthesis apparatus is connected to the gas mixture inlet of the separation apparatus and the reactant gas outlet of the separation apparatus is connected to the reactant inlet of the ammonia synthesis apparatus. This has the result that unreacted gas mixture of hydrogen and nitrogen is recirculated, this too being known from the classical Haber-Bosch process. The product outlet of the ammonia synthesis apparatus is connected to the gas mixture inlet of the separation apparatus via a first heat exchanger. This makes it possible to remove the heat of the exothermic process formed in the ammonia synthesis.

According to the invention, the ammonia synthesis apparatus comprises a pyrolysis reactor for conversion of hydrocarbon into carbon and hydrogen. The pyrolysis reactor has a hydrocarbon inlet and a hydrogen outlet. The hydrogen outlet of the pyrolysis reactor is connected to the reactant inlet of the ammonia synthesis apparatus. Furthermore, the reactant gas outlet of the separation apparatus is connected to the hydrocarbon inlet of the pyrolysis reactor. In a pyrolysis reactor, a hydrocarbon is separated into carbon (solid) and hydrogen (gas). In contrast to the presently customary processes of steam reforming and subsequent water gas shift reaction, this does not form CO₂ but rather carbon in solid form. This may be stored comparatively reliably in order thus to reliably avoid CO₂ emissions. The carbon may also be further used in a non-CO₂-emitting manner.

Since the pyrolysis does not go to completion, a certain remainder of hydrocarbons may remain in the hydrogen stream. Since subsequently in the ammonia synthesis there is a circuit between the converter and the separation apparatus these hydrocarbons would accumulate over time. In order to solve this problem a substream is separated between the separation apparatus and the converter and recycled into the pyrolysis reactor where the hydrocarbons may be pyrolyzed. This results in a low but stable level of hydrocarbons in the ammonia synthesis circuit.

A further effect is that, in contrast to steam reforming, no carbon monoxide can be formed. An apparatus for converting carbon monoxide into methane between the steam reformer and the actual Haber-Bosch process can therefore be dispensed with.

In a further embodiment of the invention a methanizer is arranged downstream of the pyrolysis reactor and upstream of the converter. If pure methane for example were used as reactant, this step which is typically required after a steam reforming would be superfluous since no carbon monoxide catalyst poison can be formed without oxygen. However, some natural gas deposits comprise a proportion of carbon dioxide and/or carbon monoxide. When using such a starting material the use of a methanizer for reacting any carbon monoxide present with hydrogen to afford methane and carbon dioxide would be advantageous to protect the catalyst in the converter.

In a further embodiment of the invention, the ammonia synthesis reactant gas stream exiting the separation apparatus is divided using a controllable valve into a first substream to the converter and a second substream to the pyrolysis reactor. It is particularly preferable when the controllable valve is connected to a control apparatus, wherein the control apparatus is connected to an analysis apparatus, wherein the analysis apparatus is arranged within the ammonia synthesis reactant gas stream between the separation apparatus and the converter including the first substream or within the ammonia synthesis reactant gas stream between the converter and the separation apparatus. The analysis apparatus is configured for quantitative detection of hydrocarbons. Quantitative detection of hydrocarbons comprises both direct detection of the concentration of the hydrocarbons and detection of a parameter correlated with the concentration of the hydrocarbons, for example heat capacity. The higher the concentration of hydrocarbon within the Haber-Bosch circuit, the greater the proportion of the second substream relative to the first substream that is selected through appropriate control of the controllable valve by the control apparatus.

In a further embodiment of the invention, the ammonia synthesis apparatus comprises an air separation apparatus. The air separation apparatus comprises a nitrogen outlet, wherein the nitrogen outlet of the air separation apparatus is connected to the reactant inlet of the ammonia synthesis apparatus. The nitrogen outlet of the air separation apparatus is preferably connected to the reactant inlet of the ammonia synthesis apparatus via a nitrogen compressor. The air separation apparatus further comprises an oxygen outlet. The oxygen may either be utilized in other processes or vented to atmosphere. It is preferable when the air separation apparatus comprises a membrane for air separation since this is more energy efficient than air separation by the Linde process. It is alternatively possible to obtain nitrogen from the evaporation of liquid nitrogen for example.

In a further embodiment of the invention, the nitrogen outlet of the air separation apparatus is connected to the reactant inlet of the ammonia synthesis apparatus via an oxygen filter apparatus. Since it is not guaranteed that the hydrogen stream contains no hydrocarbons after a pyrolysis process, it would be critical if oxygen were to be introduced even in a low concentration since this could form carbon dioxide which in turn is to be avoided as a catalyst poison. An oxygen filter apparatus may for example have a large surface area of an easily corroding material, for example a non-noble metal. Any oxygen is thus chemically bonded to the surface. The effect can be enhanced by a magnetic field since oxygen is paramagnetic and nitrogen is diamagnetic.

In a further embodiment of the invention, the nitrogen outlet of the air separation apparatus is connected to the reactant inlet of the ammonia synthesis apparatus via the first heat exchanger. This makes it possible in comparatively easy fashion to bring the nitrogen stream to the temperature it should have upon being supplied to the converter.

In a first embodiment of the invention, the first heat exchanger is connected to a heat transfer fluid system. The nitrogen outlet of the air separation apparatus is connected to the reactant inlet of the ammonia synthesis apparatus via the second heat exchanger. Furthermore, the hydrocarbon inlet of the pyrolysis reactor is connected to a hydrocarbon source, wherein the hydrocarbon inlet of the pyrolysis reactor is connected to a hydrocarbon source via a third heat exchanger. The second heat exchanger and the third heat exchanger are connected to the heat transfer fluid system. This makes it possible to transfer the heat removed at the first heat exchanger to the second heat exchanger and to the third heat exchanger and thus to heat both reactant streams.

In a further embodiment of the invention, the hydrocarbon inlet of the pyrolysis reactor is connected to a hydrocarbon source, wherein the hydrocarbon inlet of the pyrolysis reactor is connected to a hydrocarbon source via the first heat exchanger.

In a further embodiment of the invention, the hydrogen outlet of the pyrolysis reactor is connected to the reactant inlet of the ammonia synthesis apparatus via a first compressor. Furthermore, the reactant gas outlet of the separation apparatus is connected to the hydrocarbon inlet of the pyrolysis reactor via a decompression apparatus. The first compressor is coupled to the expansion decompression apparatus. The Haber-Bosch process is typically operated at very high pressures to shift the equilibrium towards the product ammonia. The pyrolysis by contrast is often performed at lower pressures. To utilize the energy released by the gas recycled into the pyrolysis reactor when it is brought from high pressure to a lower pressure level of the pyrolysis reactor the first compressor is coupled to the decompression apparatus, for example via only one common axis.

In a further embodiment of the invention, the pyrolysis reactor is configured for a pressure of 1 bar to 20 bar and a temperature of 600° C. to 1500° C. The pyrolysis reactor is particularly preferably configured for a pressure of 2 bar to 10 bar. Having regard to temperature there are various optimal temperature ranges that are attributable to different types of pyrolysis. The pyrolysis reactor comprises a metal melt, a moving bed, or a plasma. These technologies of pyrolysis of hydrocarbons have proven technologically ready for large industrial scale use. The pyrolysis reactor may thus be configured for a temperature range of 600° C. to 900° C. for example. This is optimal for a metal melt pyrolysis reactor for example. The pyrolysis reactor may alternatively be configured for a temperature range of 900° C. to 1500° C., preferably of 1200 ° C. to 1500° C.

The pyrolysis reactor may particularly preferably be configured according to WO 2019/145279 A1.

In a further embodiment of the invention, the pyrolysis reactor has electrical heating. This makes it possible to avoid CO₂ emissions for providing the energy required for the pyrolysis using electricity from renewable energy sources.

In a further aspect, the invention relates to a process for synthesis of ammonia from a hydrocarbon, wherein the process comprises the steps of:
a) supplying a hydrocarbon into a pyrolysis reactor,
b) pyrolyzing the hydrocarbon to afford carbon and hydrogen in the pyrolysis reactor,
c) passing the hydrogen from the pyrolysis reactor into a converter,
d) supplying nitrogen to the converter,
e) reacting the hydrogen and the nitrogen to afford ammonia in the converter,
f) cooling the ammonia synthesis product gas stream in a first heat exchanger,
g) separating the ammonia from the ammonia synthesis product gas stream in a separation apparatus and obtaining an ammonia synthesis reactant gas stream,
h) dividing the ammonia synthesis reactant gas stream into a first substream and a second substream,
i) passing the first substream into the converter,
j) passing the second substream into the pyrolysis reactor.

It is preferable when the process according to the invention is performed in an apparatus according to the invention.

By way of process steps h) and j) a portion of the ammonia synthesis reactant gas stream is recycled to decompose hydrocarbons present therein and thus prevent accumulation.

In a further embodiment of the invention, the pyrolysis in step b) is not carried out catalytically. A purely thermal pyrolysis is thus preferably carried out.

In a further embodiment of the invention, methane is pyrolyzed in step b). Pyrolysis of methane is advantageous per se and the steam reforming used for ammonia synthesis today likewise employs mainly methane, thus making it possible to switch to the process according to the invention relatively easily to reduce CO₂ emissions markedly while using the existing supply infrastructure.

In a further embodiment of the invention, during the supplying of the hydrocarbon in step a) said hydrocarbon is heated using the energy withdrawn from the ammonia synthesis product gas stream in the first heat exchanger.

In a further embodiment of the invention, during the supplying of the nitrogen in step d) said nitrogen is heated using the energy withdrawn from the ammonia synthesis product gas stream in the first heat exchanger.

In a further embodiment of the invention, the hydrogen stream is compressed during the passing of said stream from the pyrolysis reactor into the converter in step c).

In a further embodiment of the invention, the second substream is decompressed, wherein the energy obtained via the decompressing is utilized for compressing the hydrogen stream. This may preferably be effected in such a way that the first compressor and the decompression apparatus are coupled via a common shaft for example.

In a further embodiment of the invention, the pyrolysis reactor and the converter are operated at identical pressure. This embodiment is particularly preferable since this avoids energy losses through compression and decompression. On the other hand, this embodiment places very high demands on the pyrolysis reactor to avoid soot formation in the gas phase, since as a result of the relatively high pressure and the accordingly lower average distance between the molecules in the gas phase the risk of formation of carbon particles in the gas phase is relatively high.

In a further embodiment of the invention, the dividing of the ammonia synthesis reactant gas stream in step h) is carried out depending on the hydrocarbon content (fraction) of the ammonia synthesis reactant gas stream. In particular, the hydrocarbon content in the ammonia synthesis reactant gas stream or else in the ammonia synthesis product gas stream is detected directly or indirectly. Direct detection would be possible by IR for example and indirect detection would be possible by thermal conductivity measurement for example. The greater the detected hydrocarbon content the greater the selected proportion of the second substream.

In a further embodiment of the invention, the pyrolysis reactor is electrically heated. This makes it particularly easy to use energy from a renewable energy source and thus without CO₂ emissions. To this end, the ammonia synthesis apparatus particularly preferably comprises a wind power plant, a solar power plant, and an energy storage means. This energy mix and intermediate storage makes it possible to achieve comparatively reliable continuous operation. If required, electrical energy may be supplemented from a public supply grid.

In a further embodiment of the invention, the carbon produced in step b) is sent for disposal, i.e. end-storage. This permanently and reliably avoids introduction of the carbon into the atmosphere in the form of CO₂.

The apparatus according to the invention is more particularly elucidated hereinbelow with reference to exemplary embodiments shown in the drawings.

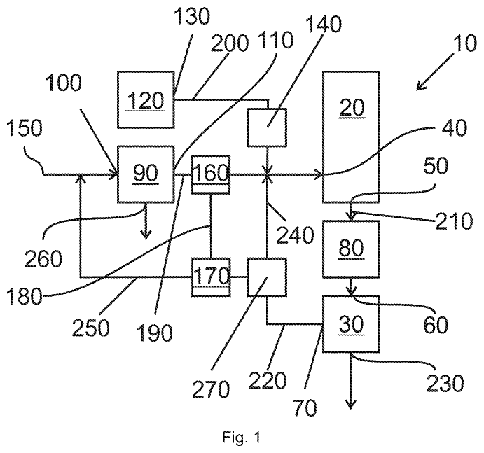

FIG. 1 first exemplary embodiment

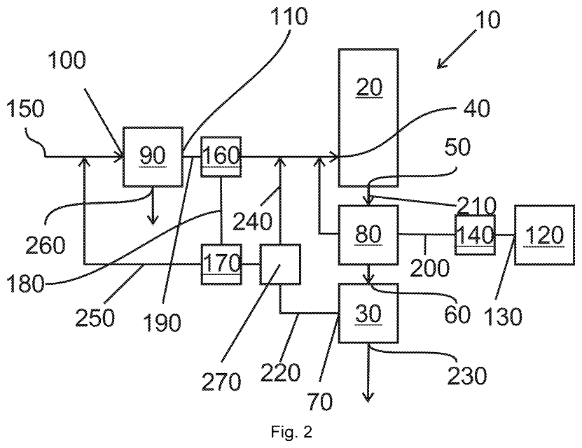

FIG. 2 second exemplary embodiment

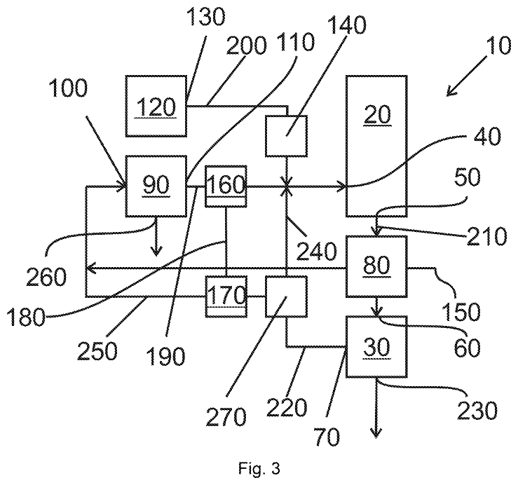

FIG. 3 third exemplary embodiment

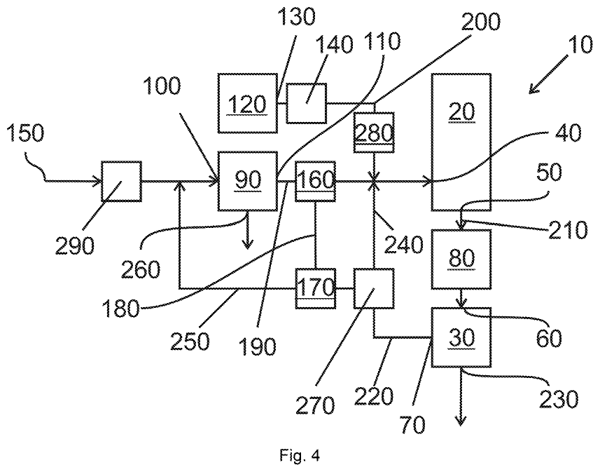

FIG. 4 fourth exemplary embodiment

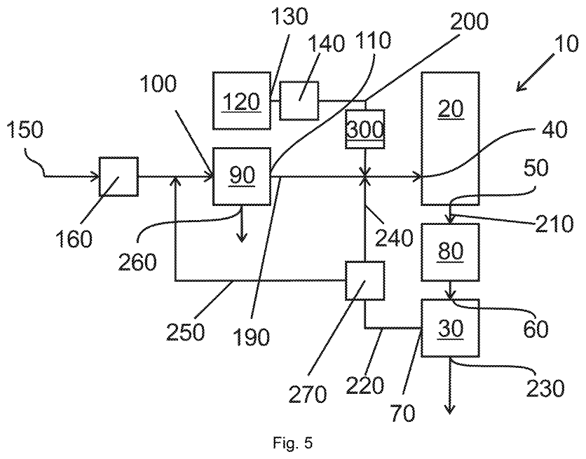

FIG. 5 Fifth Exemplary Embodiment

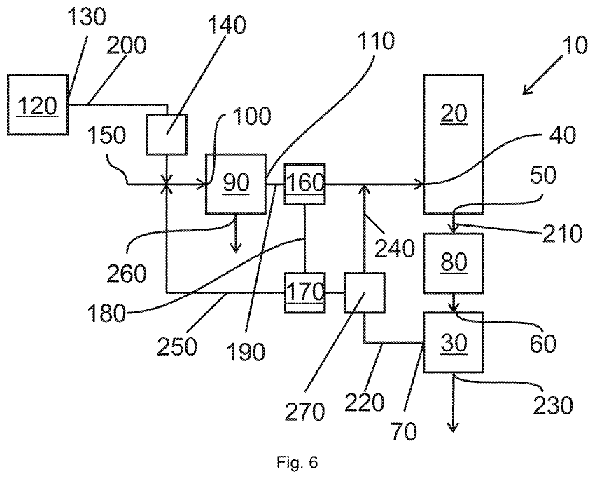

FIG. 6 Sixth Exemplary Embodiment

Identical components are in each case provided with identical reference symbols in the following exemplary embodiments.

The first exemplary embodiment is hereinbelow described in more detail, the further exemplary embodiments elaborating on the differences.

FIG. 1 shows a first exemplary embodiment of an inventive ammonia synthesis apparatus 10. The ammonia synthesis apparatus 10 comprises a hydrocarbon source 150, for example a connection to a methane gas network. The hydrocarbon is passed via a hydrocarbon inlet 100 into a pyrolysis reactor 90 and therein subjected to thermal decomposition, for example at 1200° C. to 1500° C., to afford carbon and hydrogen. The pyrolysis reactor may be constructed as a moving bed reactor for example, wherein cold hydrocarbon is introduced at the bottom.

This ascends while the hydrocarbon is heated by carbon running in countercurrent, this in turn cooling the carbon. In the middle of the pyrolysis reactor 90, an electrical heating of the carbon particles is effected and results in pyrolysis of hydrocarbons and thus in growth of the carbon. In the course of its further ascent, the hydrogen heats the carbon running in countercurrent, thus preferably cooling the hydrogen to a temperature in the order of magnitude of the Haber-Bosch process. The hydrogen exits the pyrolysis reactor 90 through the hydrogen outlet 110. The hydrogen stream 190 is compressed with the first compressor 160 and supplied to the reactor inlet 40 of the converter 20. Since in contrast to steam reforming the hydrogen stream 190 comprises no nitrogen, the nitrogen is supplied separately. To this end, the ammonia synthesis apparatus 10 comprises an air separation apparatus 120. The nitrogen exits the air separation apparatus 120 via the nitrogen outlet 130. In the example shown the nitrogen stream is passed to the reactant inlet 40 of the converted 20 through an optional oxygen filter apparatus 140. The converter 20 effects conversion of nitrogen and hydrogen to afford ammonia. The ammonia synthesis product gas stream 210 exits the converter 20 via the product outlet 50 and via the first heat exchanger 80 is supplied via the gas mixture inlet 60 to the separation apparatus 30. The product ammonia is separated here and via the ammonia outlet 230 supplied to a urea synthesis for example. What remains is a mixture of unreacted hydrogen and unreacted nitrogen, which may contain hydrocarbons which have not reacted or not completely reacted in the pyrolysis reactor. This mixture exits the separation apparatus 30 via the reactor outlet 70 as ammonia synthesis reactant gas stream 200. The largest portion of the ammonia synthesis reactant gas stream 200 is directly recycled to the reactor inlet 40 of the converter 20 as first substream 240. Another portion of the ammonia synthesis reactant gas stream 220 is separated at valve 270 as second substream 250 and recycled to the hydrocarbon inlet 100 of the pyrolysis reactor 90 as second substream 250. Since the ammonia synthesis is typically carried out under much higher pressures, a decompression apparatus 170 which is connected to the first compressor 160 via a coupling to utilize the liberated energy is arranged in the second substream 250. To discharge the carbon from the pyrolysis reactor 90 said reactor has a carbon outlet 260.

As described above, only the differences relative to the first exemplary embodiment will be elaborated upon.

The second exemplary embodiment shown in FIG. 2 differs from the first exemplary embodiment in that the nitrogen is passed directly through the first heat exchanger 80 and thus directly heated by the process heat of the ammonia synthesis.

FIG. 3 is the third exemplary embodiment in which the hydrocarbon from the hydrocarbon source 150 is passed directly through the first heat exchanger 80 and thus heated. The carbon exiting from the carbon outlet 260 may thus be comparatively warmer and could therefore be utilized for heating the nitrogen stream 200, though this is not shown here for the sake of simplicity.

The fourth exemplary embodiment shown in FIG. 4 exhibits, in addition to the first exemplary embodiment, a second heat exchanger 280 in the nitrogen stream 200 and a third heat exchanger 290 for heating the hydrocarbon between the hydrocarbon source 150 and the pyrolysis reactor 90. The first heat exchanger 80, the second heat exchanger 280 and the third heat exchanger 290 are connected to one other via a heat transfer fluid system, not shown here for the sake of simplicity. The resulting process heat can be delivered to both reactant streams.

FIG. 5 shows a fifth exemplary embodiment in which the pyrolysis reactor 90 operates at the same pressure level as the converter 20. To this end the first compressor was displaced from the hydrogen stream 190 and is now arranged between the hydrocarbon source 150 and the pyrolysis reactor 90; the decompression apparatus 170 and thus also the coupling 180 are omitted. The nitrogen stream 200 additionally has a second compressor 300 arranged in it which is preferably also present in the other exemplary embodiments.

The sixth exemplary embodiment is shown in FIG. 6 and differs from the first exemplary embodiment in that the nitrogen stream does not open into the hydrogen stream 190 and thus into the reactant inlet 40 of the converter 20 but rather opens into the hydrocarbon inlet 100 of the pyrolysis reactor 90. The advantage of this embodiment is that the collision probability between hydrocarbon molecules, and thus soot formation, can be reduced. The disadvantage, by contrast, is that the nitrogen must likewise be heated to the pyrolysis temperature. However, this energy can be recovered again at the end of the pyrolysis reactor 90.

### LIST OF REFERENCE NUMERALS

10 Ammonia synthesis apparatus
20 Converter
30 Separation apparatus
40 Reactant inlet
50 Product outlet
60 Gas mixture inlet
70 Reactant gas outlet
80 First heat exchanger
90 Pyrolysis reactor
100 Hydrocarbon inlet
110 Hydrogen outlet
120 Air separation apparatus
130 Nitrogen outlet
140 Oxygen filter apparatus
150 Hydrocarbon source
160 First compressor
170 Decompression apparatus
180 Coupling
190 Hydrogen stream
200 Nitrogen stream
210 Ammonia synthesis product gas stream
220 Ammonia synthesis reactant gas stream
230 Ammonia outlet
240 First substream
250 Second substream
260 Carbon outlet
270 Valve
280 Second heat exchanger
290 Third heat exchanger
300 Second compressor

1-15. (canceled)

16. An ammonia synthesis apparatus for producing hydrogen and for converting the hydrogen into ammonia, wherein the ammonia synthesis apparatus comprises:
a converter for converting nitrogen and hydrogen into ammonia;
a separation apparatus for separating the ammonia from the gas stream, wherein the ammonia synthesis apparatus has a reactant inlet and a product outlet, wherein the separation apparatus has a gas mixture inlet and a reactant gas outlet, wherein the product outlet of the ammonia synthesis apparatus is connected to the gas mixture inlet of the separation apparatus, wherein the reactant gas outlet of the separation apparatus is connected to the reactant inlet of the ammonia synthesis apparatus, wherein the product outlet of the ammonia synthesis apparatus is connected to the gas mixture inlet of the separation apparatus via a first heat exchanger; and
a pyrolysis reactor for conversion of hydrocarbon into carbon and hydrogen, wherein the pyrolysis reactor has a hydrocarbon inlet and a hydrogen outlet, wherein the hydrogen outlet of the pyrolysis reactor is connected to the reactant inlet of the ammonia synthesis apparatus, wherein the reactant gas outlet of the separation apparatus is connected to the hydrocarbon inlet of the pyrolysis reactor.

17. The ammonia synthesis apparatus as claimed in claim 16, further comprising:
an air separation apparatus, wherein the air separation apparatus comprises a nitrogen outlet, wherein the nitrogen outlet of the air separation apparatus is connected to the reactant inlet of the ammonia synthesis apparatus.

18. The ammonia synthesis apparatus as claimed in claim 17, wherein the nitrogen outlet of the air separation apparatus is connected to the reactant inlet of the ammonia synthesis apparatus via an oxygen filter apparatus.

19. The ammonia synthesis apparatus as claimed in claim 18 wherein the nitrogen outlet of the air separation apparatus is connected to the reactant inlet of the ammonia synthesis apparatus via the first heat exchanger.

20. The ammonia synthesis apparatus of claim 18 wherein the first heat exchanger is connected to a heat transfer fluid system, wherein the nitrogen outlet of the air separation apparatus is connected to the reactant inlet of the ammonia synthesis apparatus via the second heat exchanger, wherein the hydrocarbon inlet of the pyrolysis reactor is connected to a hydrocarbon source, wherein the hydrocarbon inlet of the pyrolysis reactor is connected to a hydrocarbon source via a third heat exchanger, wherein the second heat exchanger and the third heat exchanger are connected to the heat transfer fluid system.

21. The ammonia synthesis apparatus of claim 18 wherein the hydrocarbon inlet of the pyrolysis reactor is connected to a hydrocarbon source, wherein the hydrocarbon inlet of the pyrolysis reactor is connected to a hydrocarbon source via the first heat exchanger.

22. The ammonia synthesis apparatus of claim 21 wherein the hydrogen outlet of the pyrolysis reactor is connected to the reactant inlet of the ammonia synthesis apparatus via a first compressor, wherein the reactant gas outlet of the separation apparatus is connected to the hydrocarbon inlet of the pyrolysis reactor via a decompression apparatus, wherein the first compressor is coupled to the decompression apparatus.

23. The ammonia synthesis apparatus of claim 21 wherein the pyrolysis reactor is configured for a pressure of 1 bar to 20 bar and a temperature of 600° C. to 1500°C.

24. A process for synthesis of ammonia from a hydrocarbon, wherein the process comprises the steps of:
a) supplying a hydrocarbon into a pyrolysis reactor;
b) pyrolyzing the hydrocarbon to afford carbon and hydrogen in the pyrolysis reactor;
c) passing the hydrogen from the pyrolysis reactor into a converter;
d) supplying nitrogen to the converter;
e) converting the hydrogen and the nitrogen into ammonia in the converter;
f) cooling the ammonia synthesis product gas stream in a first heat exchanger;
g) separating the ammonia from the ammonia synthesis product gas stream in a separation apparatus and obtaining an ammonia synthesis reactant gas stream;
h) dividing the ammonia synthesis reactant gas stream into a first substream and a second substream;
i) passing the first substream into the converter; and
j) passing the second substream into the pyrolysis reactor.

25. The process as claimed in claim 24 wherein during the supplying of the hydrocarbon in step a), said hydrocarbon is heated using the energy withdrawn from the ammonia synthesis product gas stream in the first heat exchanger.

26. The process as claimed in claim 25 wherein during the supplying of the nitrogen in step d), said nitrogen is heated using the energy withdrawn from the ammonia synthesis product gas stream in the first heat exchanger.

27. The process as claimed in claim 26 wherein the hydrogen stream is compressed during the passing of said stream from the pyrolysis reactor into the converter in step c).

28. The process as claimed in claim 27 wherein the second substream is decompressed, wherein the energy obtained via the decompressing is utilized for compressing the hydrogen stream.

29. The process as claimed in claim 26 wherein the pyrolysis reactor and the converter are operated at the same pressure.

30. The process as claimed in claim 28 wherein the dividing of the ammonia synthesis reactant gas stream in step h) is carried out depending on the hydrocarbon content of the ammonia synthesis reactant gas stream.
